(19) United States
(12) Patent Application Publication
(10) Pub. No.: US 2005/0026525 A1
(43) Pub. Date: Feb. 3, 2005

(54) Composite material with synthetic composite matrix, method for producing said material, and its application

(75) Inventors: Michael Vollbrecht, Hannover (DE); Claus Zurbig, Hannover (DE); Bettina Lohre, Peine (DE); Christian Noll, Hannover (DE)

Correspondence Address: DARBY & DARBY P.C., P. O. BOX 5257, NEW YORK, NY, 10150-5257, US

(73) Assignee: Benecke-Kaliko AG, Hannover (DE)

(21) Appl. No.: 10/884,624

(22) Filed: Jul. 2, 2004

(30) Foreign Application Priority Data
Jul. 3, 2003 (DE) 103 30 099.6

(51) Int. Cl. B32B 27/12; B32B 27/04; B32B 5/18; B32B 3/26

(52) U.S. Cl. 442/286; 442/239; 442/242; 442/76; 442/123

(57) ABSTRACT

Described is a composite material having a flexible synthetic composite matrix, and a textile support web embedded therein. This composite material is characterized in that the composite matrix is based upon a cross-linked polyurethane, in that a textile support web is integrated into the polyurethane composite matrix, and in that a textile patterned surface is formed on at least one side of the polyurethane composite matrix. The textile support web is preferably comprised of a woven fabric or knitted fabric and is expediently arranged centrally within the polyurethane composite matrix. Advantageously, the process for producing this composite material consists in that during the cross-linking of a reactive parent material of a polyurethane, a textile support web is completely inserted into the parent material of the polyurethane matrix, which has been applied to a subcarrier, and a textile patterned surface is bonded to the cross-linking polyurethane layer, as soon as the inner stability will allow an even, single-sided embedding without the material breaking through, after which the polyurethane layer is reacted out. This material is characterized in that it can be bent, folded, and rolled, and can be sewn. It exhibits favorable properties with respect to flammability rating, color fastness, and resistance to fading. The composite matrix based upon a cross-linked polyurethane is preferably formed using a reactive high-solids polyurethane (PUR) system.

The invention relates to a composite material having a flexible synthetic composite matrix and a support web embedded therein, a method for producing a composite material of this type, and its application.

Composite entities are understood as entities made of composite materials that are obtained via the combination of various materials, and whose chemical, physical and other properties are superior to those of the individual components. In addition to textile composite materials, non-woven materials, laminates, i.e. materials that are bonded to one another in a sandwich construction by means of adhesive or lamination (e.g. plywood, multi-layer films and laminates), such composite materials also include imitation leather. Imitation leather is understood as a multi-layer, flexible composite entity that comprises a polymer in the surface layer and a support material, especially comprised of a textile, a non-woven material, or a foamed material, e.g. made of PVC, polyolefin, or polyurethane. The polymer surface layer is responsible for the material's abrasion resistance and impact resistance, and determines the appearance of the material, while the support material provides its strength and flexibility. As coating polymers, i.a. polyurethanes are used. Basically, differentiation is made between single- and dual-component coating systems.

Thus composite materials that, i.a., enmesh a textile material are known in the art. For example, DE 39 07 453 A1 concerns a coated textile material comprised of at least one textile support base and at least one outer, flexible rubber or synthetic layer. One key characterizing feature of the known coated textile material is the formation of a polyimide layer, which is very securely bonded to the respective adjacent layer. It is preferable for the polyimide layer to be bonded to the adjacent layer by means of adhesives, or for the adjacent layer to be a rubber layer to which the polyimide layer is bonded by means of cross-linking. Further, it is emphasized as a preferred embodiment that a rubber layer of customary thickness is provided on one surface of the support web, while on the other surface a thin rubber layer is provided as an adhesive agent to the polyimide layer. Furthermore, in DE 39 07 453 A1 a process is disclosed, according to which the described coated textile materials are produced. Pursuant to said process, on both sides of a (textile) support web a fluorinated rubber mixture is applied and dried, after which a polyimide layer is applied to at least one side. The textile material coated in this manner is subjected to a vulcanization process. The above-mentioned polyimide layer can be applied in the form of a polyimide film to the pre-coated support web. It may also be applied, however, using a doctor blade or in a spray process. The polyimide itself is a “costly material”. Considering its high tear resistance, it should be possible to use a less expensive support material. With this, a considerably longer service life of the coated textile material in comparison with known rubber-coated fabrics could be achieved. The known coated textile material can be used in a variety of applications. For instance, it is suitable for use in the manufacture of protective clothing, tarpaulins and/or truck covers.

The main disadvantage of the above-described state of the art lies in the complicated process required to produce the composite material, especially if a direct coating is involved. The greatest disadvantage in this connection is when an uneven settling occurs. Furthermore, problems with adhesion, layer separation, and even the unintended formation of air pockets can arise.

It was thus the object of the invention to overcome the disadvantages of the described state of the art, specifically to propose a composite material having a flexible synthetic composite matrix and a textile support web embedded therein, which can be manufactured via a simplified process, and wherein said material can also be used as a double-sided, reinforced imitation leather. This imitation leather should be optically textile and “imitation leather”, water-tight, tear resistant, and sewable.

Pursuant to the invention, the stated object is attained in that the composite matrix is based on a cross-linked polyurethane, in that a textile support web is integrated into the polyurethane composite matrix, and in that a textile patterned surface is formed on at least one side of the polyurethane composite matrix.

It is of particular advantage for the surface of the polyurethane composite matrix that faces away from the textile patterned surface to be leather-grained. With respect to the grain, it is specified that the grain can be formed using both technical and fashion patterns, by means of patterned intermediate supports (paper, silicon, etc.).

It is further advantageous for another textile patterned surface to be formed on the surface of the polyurethane composite matrix that faces away from the (first) textile patterned surface. With this step, a water-tight, flexible, textile composite material or, as the case may be, boat tarpaulin can be formed.

Within the scope of the invention, adhesive layers can be provided between the individual layers, wherein it is especially beneficial for an adhesive layer, especially one with a polyurethane base, to be positioned between at least one textile patterned surface and the polyurethane composite matrix. In general, it is expedient for the textile support web to be arranged centrally within the polyurethane composite matrix. For the adhesive layer, customarily used adhesives, adhesive laminates, and adhesive films, such as hot melt adhesive films, can be used. Permanently flat bonding adhesive layers that are thin and do not interfere with the remaining layers in terms of their properties and characteristics, or with the processability of the finished product, are preferred. The single- or multi-ply adhesive layer is preferably no thicker than 0.2 mm. Single- or multi-ply pressure-sensitive adhesive layers in the form of solvent-based or dispersion adhesives are preferred. Especially, polyurethane adhesives such as 2-K-PUR systems are used.

The textile support web is an important integrated component of the composite material specified in the invention. It ensures the desirable level of tear resistance and sewability. In the construction of the textile support web, the invention is subject to no significant restrictions. With respect to the stated requirements, especially with respect to tear resistance and sewability, it is expedient for said support web to be comprised of a woven or knitted fabric. The physical properties of the woven or knitted fabric, which can be adjusted with advantage, consist in the strength being increased and the elongation being limited.

These requirements are fulfilled when the woven or knitted fabric is comprised of synthetic fibers, especially fibers made of polyesters, polyamide, or polyacrylonitrile.

The textile patterned surface also is preferably comprised of a woven fabric, especially in the form of a flat-woven material, which preferably is comprised of polyacrylonitrile. In some cases it is desirable for the textile support side to be dyed, especially black. With respect to the described advantageous applications of the composite material specified in the invention, it is expedient for both the textile support web and the textile patterned surface to be capable of being bent and/or folded and rolled. These requirements are fulfilled when the integrated textile web is embedded in a PUR mass, and the textile patterned surface is not inlaid too deeply in the laminate coating. It is further preferred for the textile support web to be electrically conductive and/or fungicidal; this can be accomplished, for example, by vapor-coating the textile support web with a conductive layer, or by inserting conductive fibers, and if desired, additionally equipping them with fungicide.

With respect to some applications, it is advantageous for the textile patterned surface to be impregnated with a hydrophobing agent, especially in the form of a fluorocarbon resin. In some cases it is expedient to apply a covering film or a coat of sealing lacquer on at least one of the textile patterned surfaces, in order to make it less sensitive to environmental factors, such as dust, etc.

Certain requirements are placed on the composite material specified in the invention in terms of tear resistance. These are determined primarily by the textile support web and/or the textile patterned surface. It is preferable for the tear resistance, measured in accordance with DIN 53331, to be greater than 500 N/5 cm, especially greater than 700 N/5 cm, because then its use in protective coverings against inclement weather, boat tarpaulins, etc. is ensured.

With respect to the possible applications for the composite material specified in the invention, which will be addressed further below, various properties are expediently adjusted. For instance, when the composite material specified in the invention is used in the automotive industry, it is advantageous for its flammability rating in accordance with FMVSS 302 to be less than 100 mm, as then it is possible for the material to be used as a fabric for convertible tops. Furthermore, it is preferable for the color fastness of the material (rubbing fastness) in accordance with DIN 54021 (dry/surface material) to be equal to or greater than 4, according to DIN 54002 (wet/surface material) to be equal to or greater than 4, and the fade resistance according to DIN 75202/2 (surface material) and DIN 54001 (sub-surface material) to be equal to or greater than 4, and/or the artificial weathering after 1,000 h in accordance with DIN 53387 (surface material) to be equal to or greater than 4.

It has proven advantageous for the composite material specified in the invention, especially when it is used in the applications described further below, to be 0.7 to 5 mm thick, especially approximately 0.7 to 1.2 mm thick. As long as the measurement is greater than approximately 0.7 mm, then the composite material is weather-tight, flexible, and suitable for use in “tarpaulin materials”.

A further key characterizing feature of the invention is that the composite matrix is based upon a cross-linked polyurethane, especially upon a cross-linked polyurethane that is formed using a reactive high-solids polyurethane (PUR) system. These are two-component systems, in which during the polymerization, the molecular weight of the polymer is gradually built up using a chain extender. These systems represent compositions having a high solids content and a low solvent content, which for reasons of favorable, environmentally-friendly applications are being employed to an increasing degree. With the use of a high-solids-polyurethane system, aliphatic and aromatic isocyanates can be used with equal success, which are then converted using polyhydroxy compounds to form the corresponding polyurethane.

The two-component coating systems are reactive mixtures, e.g. of functionalized prepolymers and cross-linking agents, having low proportions of organic solvents (<5 to 10%). In contrast to the single-component systems, these “high-solid systems” polymerize under the processing conditions and thus form the urethane film. In order to ensure an adequate pot life (time span during which a batch remains processable after all the constituents have been mixed together) at room temperature, isocyanate components, in which the terminal isocyanate groups are reversibly protected by blocking agents (e.g. 2-butanone oxide) are added. The chemical reaction then runs in two stages. First, at temperatures above 140° C. the blocking agent is split off, and the free NCO group is re-formed. In a second stage, the isocyanate terminal group reacts with the chain extender, increasing the molecular weight. In this manner the molecular weight of the polymer gradually builds up to a polyurethane film.

The above-described isocyanates used in the production of the polyurethanes are not limited in any way. Preferred aliphatic diisocyanates include hexamethylene diisocyanates, isophorone diisocyanates, 1,4-dicyclohexane diisocyanates, and mixtures of these. Preferred aromatic diisocyanates are 2,4-toluylene diisocyanate, 2,2′-, 2,4′- and 4,4′-diphenylmethane diisocyanates, 4-4′-diisocyanate diphenylethane-(1,2), 1,5-naphthalene diisocyanate, and mixtures of these.

The selection of polyhydroxy compounds used pursuant to the invention also is not particularly restricted. These can be either aliphatic or aromatic. Preferred polyhydroxy compounds include polyether polyols, such as polyether diols, polytetramethylene ether diols, polyester polyols, such as ethanediol polyadipate, 1,4-butanediol polyadipate, ethanediol butanediol-1,4-polyadipate, 1,6-hexanediol neopentylglycol polyadipate, polycaprolactone, polymers containing hydroxyl groups, such as poly(oxymethylene), poly(oxypropylene)glycols, glycols of dimeric fatty acids, and mixtures of these.

The single-component coating materials are processed as solutions (solids content approximately 20 to 30%) in organic solvents (e.g. DMF, 2-propanol, toluene) or as dispersions (solids content approximately 20 to 40%). After being spread out, e.g. on a web, as is described in DE-A4422871, the film is formed by evaporating the solvent in a drying tunnel. By adding slow-reacting polyfunctional cross-linking agents (e.g. aliphatic polyisocyanates), single-component polyurethanes can be post cross-linked, in order to improve the properties, such as chemical resistance, for example. Due to the low solids content, single-component polyurethane coating systems are well suited for the application of thin films.

It is especially advantageous for the composite material specified in the invention, as described above, to be produced by means of a process that is characterized in that during the cross-linking of a reactive parent material of the polyurethane, a textile support web, especially one of the type described above, is inserted completely into the parent material of the polyurethane matrix, which has been applied to an auxiliary support, and a textile patterned surface is bonded to the cross-linking polyurethane layer as soon as its internal stability will permit an even embedding without the mass breaking through, after which the polyurethane layer is reacted out. The reactive parent materials of a particularly well-suited polyurethane have already been described above in connection with a “high-solids polyurethane”, to which reference is made.

No special requirements are made with respect to the auxiliary support. It needs only to ensure that if necessary, the surface pattern of the composite matrix is formed.

In other words, a high-solid PUR coating is preferably applied to a patterned intermediate support, wherein a textile support web settles into the mass, as a function of the process, and at the same time is bonded with patterned flat-woven fabrics and/or interwoven X-bodies (S+Z degree).

The textile support web and the textile patterned surface and/or the textile patterned surfaces were also already described above, and reference is likewise made to them. What is important in this connection is that as soon as the textile support web, which especially is centered, sinks in a calculated manner into the reactive parent material of a polyurethane, especially the high-solids polyurethane, so that it becomes enmeshed in the most central arrangement possible within the polyurethane matrix, which later will be solidified by means of cross-linking [sic]. The internal strength is determined, for example, by the way in which the cross-linking structure is formed. In a preliminary test, it can easily be determined what degree of internal strength is required in order for the textile support web to be optimally enmeshed by means of an even settling and/or by means of an even single-sided embedding, especially to prevent the mass from breaking through. With respect to the mass breaking through, it must also be pointed out that this can be influenced by temperature, catalysts, and dwell time. Accordingly, as soon as the even, single-sided embedding has been completed, a textile patterned surface is applied. It completes the full reaction of the polyurethane composite matrix with the enmeshed textile support web. The reacting out and/or cross-linking can be advantageously controlled by coordinating the recirculated air and the temperature, and the employment of catalysts.

It is essential for the composite material specified in the invention to comprise at least one textile patterned surface. It is advantageous for the matrix to be introduced, for example, into a smooth structure, in order to allow a second textile patterned layer to be applied. In this case, the second textile patterned layer is preferably applied by means of lamination following completion of the synthetic composite material.

As was mentioned above in connection with the description of the composite material specified in the invention, an adhesive layer may be provided between the various layers. In the present case it is advantageous for an adhesive layer, especially one with a polyurethane base, to be applied, following the formation of the polyurethane composite matrix, to one or both faces of the polyurethane composite matrix, and afterward for the appropriate textile patterned layer to be applied in the manner described above.

The preparation of surface patterns on the top or patterned surface can be accomplished via known methods. Thus, any technologies known to an expert in the field can be employed with any type of grains. Even Le-grains (true leather) are possible. The grain can be formed via casting or also via embossing, for example in a negative drawing process.

Accordingly, with the process pursuant to the invention the cost-effective production of a new, advanced product is possible, wherein a more even settling of materials without direct coating or a breaking through of the mass is achieved. A new type of article is obtained that can be advantageously employed with laptops, pocketbooks, and portable telephone covers, and especially as pull-down covers or as fabric used for convertible tops in the automotive industry.

Below, the invention will be described in greater detail with reference to examples:

### EXAMPLE 1

Approximately 30 to 40 g/m² (solid) pigmented polyurethane are spread onto a grained polyurethane paper using a doctor blade. This is then dried at a temperature of 90 to 140° C. for a period of approximately 2 min, forming a bubble-free film. This is followed by a cooling stage. Afterward, a layer of a 2-component polyurethane is applied to the dried, pigmented polyurethane film, to a thickness of approximately 450 μm², using a doctor blade. After approximately 30 seconds, the PES tricot is laminated to the wet and highly viscous polyurethane mass in the opening. The material is then cross-linked at a temperature of approximately 150 to 160° C. for a period of 2 to 3 min. During this stage the PES tricot settles completely into the 2-component polyurethane, as a result of the drop in viscosity of the cross-linking polyurethane mass. After cooling, approximately 30 to 40 g/m² polyurethane laminate material is applied. The textile patterned fabric is laminated on, the entire composite is dried for 2 to 3 min at 150° C., cooled, and separated from the grained paper base. The grained, leather-like patterned surface is finished with a finishing lacquer comprised of polyvinyl chloride/acrylate/polyurethane in an overall thickness of 4 to 8 g/m² by means of photogravure printing.

### EXAMPLE 2

Approximately 400 to 500 g/m² “high-solid polyurethane” are spread onto a smooth intermediate support and/or onto a divider paper. The spread polyurethane is directed over a heatable cylinder, at a cylinder temperature of 180 to 200° C., and laminated over a rotatable laminating device with a 40-50 g/m² textile circular knitting material made of PES thread, in such a way that the circular knitting material becomes anchored at the center of the cross-linked polyurethane. After cooling, 40-50 g/m² polyurethane bonded laminate coating is spread on. The textile patterned fabric is laminated, dried for 2 to 3 min in the drying tunnel at 150° C., and formed into the composite. Afterward, the composite is separated from the intermediate support and rolled up. In a further processing step, the side that faces away from the textile patterned surface is coated with approximately 30 g/m² coupling agent comprised of polyurethane, and another textile made of polyacrylonitrile is anchored in the composite. The composite is further cross-linked. In this manner, a double-sided, flexible textile decorative material is produced.

1. A composite material comprising:
a flexible composite matrix of a cross-linked polyurethane;
a textile support web integrated into said composite matrix; and
a first textile patterned surface formed on at least one side of said composite matrix.

2. The composite material according to claim 1, wherein the surface of the composite matrix that faces away from said textile patterned surface is grained.

3. The composite material according to claim 1 further comprising a second textile patterned surface formed on the surface of said composite matrix opposite said first textile patterned surface.

4. The composite material according to claim 1 further comprising an adhesive layer having a polyurethane base between said first textile patterned surface and said composite matrix.

5. The composite material according to claim 3 further comprising an adhesive layer having a polyurethane base between at lest one of said first and second textile patterned surfaces and said composite matrix.

6. The composite material according to claim 1 wherein said textile support web is arranged centrally within said composite matrix.

7. The composite material according to claim 6 wherein said textile support web is comprised of a woven fabric or a knitted fabric.

8. The composite material according to claim 7, wherein said woven fabric or knitted fabric is one of a synthetic fiber.

9. The composite material according to claim 8 wherein said fiber of said woven or knitted fabric is of at least one of polyester, polyamide or polyacrylonitrile.

10. The composite material according to claim 7 wherein said textile patterned surface is comprised of a woven fabric in the form of a flat-woven fabric.

11. The composite material according to claim 1 wherein said first textile patterned surface is dyed to a predetermined color.

12. The composite material according to claim 1 wherein said textile support web and said first textile patterned surface are bendable and/or foldable and rollable.

13. The composite material accord to claim 1 that is from between about 0.7 to about 5 mm thick.

14. The composite material according to claim 13 that is from between about 0.7 to about 1.2 mm thick.

15. The composite material according to claim 1 having a tear resistance, measured in accordance with DIN 53331, greater than 500 N/5 cm.

16. The composite material of claim 15 wherein the tear resistance measured in accordance with DIN 53331, is greater than 700 N/5 cm.

17. The composite material according to claim 1 further comprising a hydrophobing agent impregnated in said textile patterned surface.

18. The composite material of claim 17 wherein said hydrophobing agent is a fluorocarbon resin.

19. The composite material according to claim 1 having a flammability rating measured in accordance with FMVSS 302 for use in the automotive industry of less than 100 mm.

20. The composite material according to claim 1 having a color fastness (rubbing fastness) in accordance with DIN 54021 (dry/surface material) equal to or greater than 4, and in accordance with DIN 54002 (wet/surface material) is equal to or greater than 4, and a fade resistance in accordance with DIN 75202/2 (surface material) and DIN 54001 (sub-surface material) equal to or greater than 4, and/or an artificial weathering after 1,000 h in accordance with DIN 53387 (surface material) equal to or greater than 4.

21. The composite material according to claim 1 wherein said composite matrix is formed of a cross-linked polyurethane, using a reactive high-solids polyurethane (PUR) system.

22. The composite material according to claim 1 wherein at least one of said textile support web and said patterned surface is electrically conductive and/or fungicidal.

23. The composite material according to claim 3 further comprising:
a covering film or a coat of sealing lacquer applied to at least one of said first and second textile patterned surfaces.

24. A method for producing a composite material comprising the steps of:
providing a textile support web;
cross-linking a reactive parent material of a polyurethane over said textile support web to form a polyurethane matrix;
applying said matrix to an auxiliary support; and
bonding a textile patterned surface to one side of said matrix as soon as the internal stability of the cross-linked polyurethane permits.

25. The method according to claim 24 further comprising the step of bonding a second textile patterned layer to the other side of said matrix.

26. The method according to claim 24 further comprising the step of applying an adhesive layer with a polyurethane base to one or both faces of said polyurethane matrix after formation of said matrix.
